(19) United States
(12) Patent Application Publication
(10) Pub. No.: US 2008/0173033 A1
(43) Pub. Date: Jul. 24, 2008

(54) VARIABLE TORQUE TRANSMITTER

(75) Inventor: David D. Colavincenzo, Castalia, OH (US)

Correspondence Address: CALFEE HALTER & GRISWOLD, LLP, 800 SUPERIOR AVENUE, SUITE 1400, CLEVELAND, OH, 44114, US

(73) Assignee: BENDIX COMMERCIAL VEHICLE SYSTEMS LLC, Elyria, OH (US)

(21) Appl. No.: 11/624,978

(22) Filed: Jan. 19, 2007

(51) Int. Cl. B60H 1/32

(52) U.S. Cl. 62/133

(57) ABSTRACT

A vehicle air compressor controller includes a compressor electronic control unit receiving a plurality of signals representing respective vehicle parameters. A variable torque transmitter is controlled by the compressor electronic control unit. The variable torque transmitter receives an engine speed from an engine of the vehicle and delivers a variable torque to a compressor of the vehicle for controlling a speed of the compressor. The variable torque is determined as a function of the engine speed and the vehicle parameters.

### BACKGROUND

The present invention relates to a vehicle compressor. It finds particular application in conjunction with controlling a speed of the vehicle compressor and will be described with particular reference thereto. It will be appreciated, however, that the invention is also amenable to other applications.

Air brake and other auxiliary systems requiring compressed air are known for tractor/trailer vehicles. In conventional tractor/trailer vehicles, the basic air system components include an air compressor with a governor valve, an air dryer, a supply reservoir tank, valves for controlling flow of the compressed air to the brake and other auxiliary systems, wheel mounted brakes and brake chambers, and other auxiliary systems. In an air brake system, for example, the compressor furnishes the compressed air for brake operation by taking free atmospheric air and compressing it to 100-120 psi. The compressed air passes from the compressor into the reservoir where it is stored until it is needed. The compressed air is held in the reservoir until it is released by the operator via the air brake control valves. When the operator utilizes the air brake control valves, air flows to the brake chambers where its energy is transformed into the mechanical force and motion necessary to apply the brakes.

As the compressed air is used, the air supply systems require periodic recharging of the air supply reservoir. Under normal operating conditions the air compressor control system has a low limit pressure of about 100 psi and a high limit pressure of about 120 psi. When the pressure in the supply reservoir tank drops below about 100 psi, the system “loads” the air compressor and opens the governor valve. When the pressure in the supply reservoir tank reaches about 120 psi the system “unloads” the air compressor and closes the governor valve.

In conventional systems, the compressor is driven by the engine and runs continuously along with the engine. As discussed above, the compressor is either loaded or unloaded as a function of the pressure in the air supply reservoir. While loaded, the compressor supplies compressed air to the compressed air system. While unloaded, the compressor continues to run, but vents the air it produces to atmosphere, or a separate volume, instead of supplying the compressed air to the compressed air system. Running the air compressor continuously with the engine contributes to additional wear and tear on the compressor. In addition, the speed at which the compressor runs at any point in time is determined as a fixed ratio of the speed at which the engine is running.

The present invention provides a new and improved apparatus and method which addresses the above-referenced problems.

### SUMMARY

A vehicle air compressor controller includes a compressor electronic control unit receiving a plurality of signals representing respective vehicle parameters. A variable torque transmitter is controlled by the compressor electronic control unit. The variable torque transmitter receives an engine speed from an engine of the vehicle and delivers a variable torque to a compressor of the vehicle for controlling a speed of the compressor. The variable torque is determined as a function of the engine speed and the vehicle parameters.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a vehicle air compressor controller system in accordance with one embodiment of an apparatus illustrating principles of the present invention;

FIG. 2 illustrates a schematic representation of a vehicle air compressor controller system in accordance with one embodiment of the apparatus shown in FIG. 1;

FIG. 3 illustrates graph showing compressor speed and clutch slippage versus engine speed one example of a vehicle air compressor controller system; and

FIG. 4 illustrates a schematic representation of a vehicle air compressor controller system in accordance with another embodiment of the apparatus shown in FIG. 1.

### DETAILED DESCRIPTION OF ILLUSTRATED EMBODIMENT

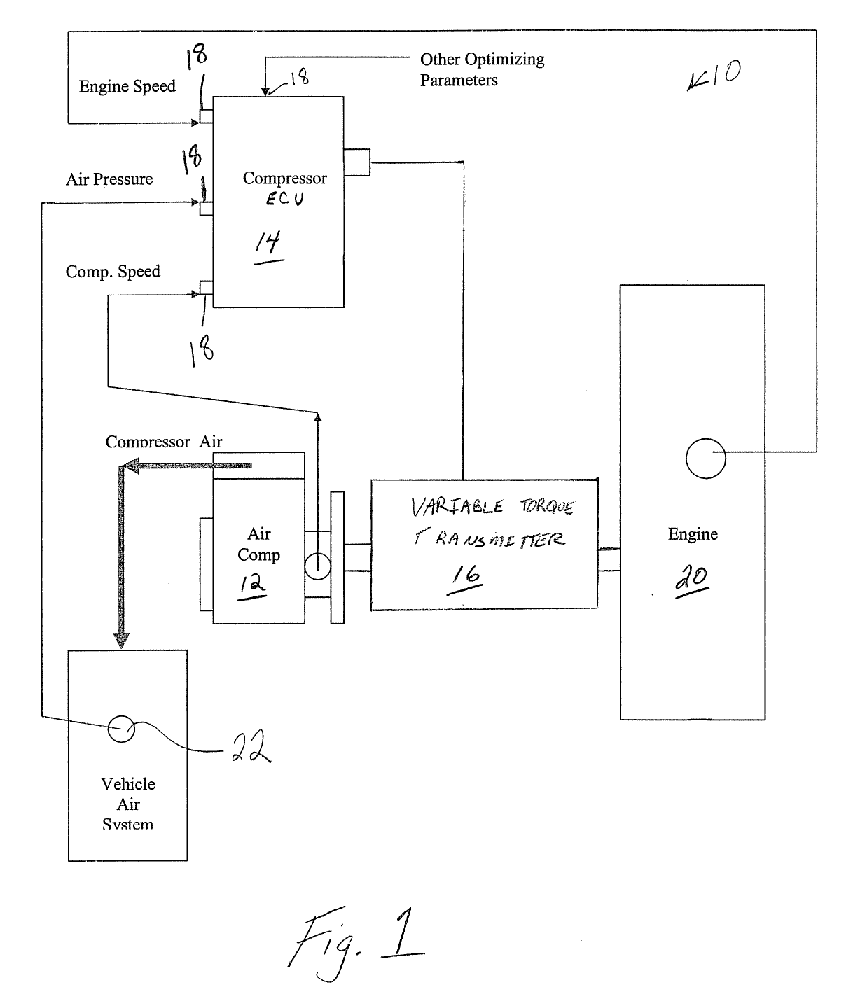

With reference to FIG. 1, a simplified component diagram of an exemplary vehicle air compressor controller system 10 is illustrated in accordance with one embodiment of an apparatus illustrating principles of the present invention. The vehicle air compressor controller system 10 includes a compressor 12 (e.g., an air compressor), a compressor electronic control unit (ECU) 14, and a variable torque transmitter 16. The ECU 14 controlling the compressor 12 (and the variable torque transmitter 16) may alternatively be one of a number of ECUs on the vehicle, e.g., the engine ECU. The variable torque transmitter 16 acts as a means for delivering a variable torque to the compressor 12 for controlling a speed of the compressor 12.

The compressor ECU 14 receives a plurality of signals representing respective vehicle parameters. Respective inputs 18 (e.g., electrical inputs) on the compressor ECU 14 act as means for providing the vehicle parameter signals to the compressor ECU 14. For example, in one embodiment, the compressor ECU 14 receives electronic signals representing a speed at which an associated engine 20 is driving the variable torque transmitter 16 (i.e., the driving speed), an actual speed at which the compressor 12 is reciprocating (i.e., the actual speed), and a pressure in an associated air tank 22 that is filled with compressed air produced by the compressor 12. The speed at which the associated engine 20 is driving the variable torque transmitter 16 is proportional to a compressor drive ratio. More specifically, the driving speed is calculated by multiplying the engine speed by a compressor drive ratio. Other vehicle parameters that may be used in the present invention include, for example, transmission retarder status, engine brake status, engine load status, vehicle speed, engine torque, engine oil temperature, engine start sequence, air suspension status, emission control devices, and/or other vehicle parameters defined in the SAE J1939 Data Link standard.

The variable torque transmitter 16 receives the engine speed from the associated engine 20. The compressor ECU 14 controls the variable torque transmitter 16 to deliver a variable torque to the compressor 12 for controlling the actual speed at which the compressor 12 reciprocates. More specifically, the compressor ECU 14 transmits a control signal (e.g., an electronic signal) to the variable torque transmitter 16 to manage a proportion of the driving speed that is transmitted to the compressor 12. In other words, the actual speed is a function of the driving speed (engine torque). The actual speed is also a function of the compressor drive ratio. In addition to being determined as a function of the driving speed, the actual speed is also determined as a function of the vehicle parameters.

In one embodiment, the variable torque transmitter 16 is a clutch. An amount of the clutch engagement determines the proportion of the driving speed that is transmitted to the compressor 12. The amount of clutch engagement is determined as a function of the engine speed and the vehicle parameters. In one embodiment, it is contemplated that the clutch is a slipping (wet) clutch, while in another embodiment the clutch is a dry clutch.

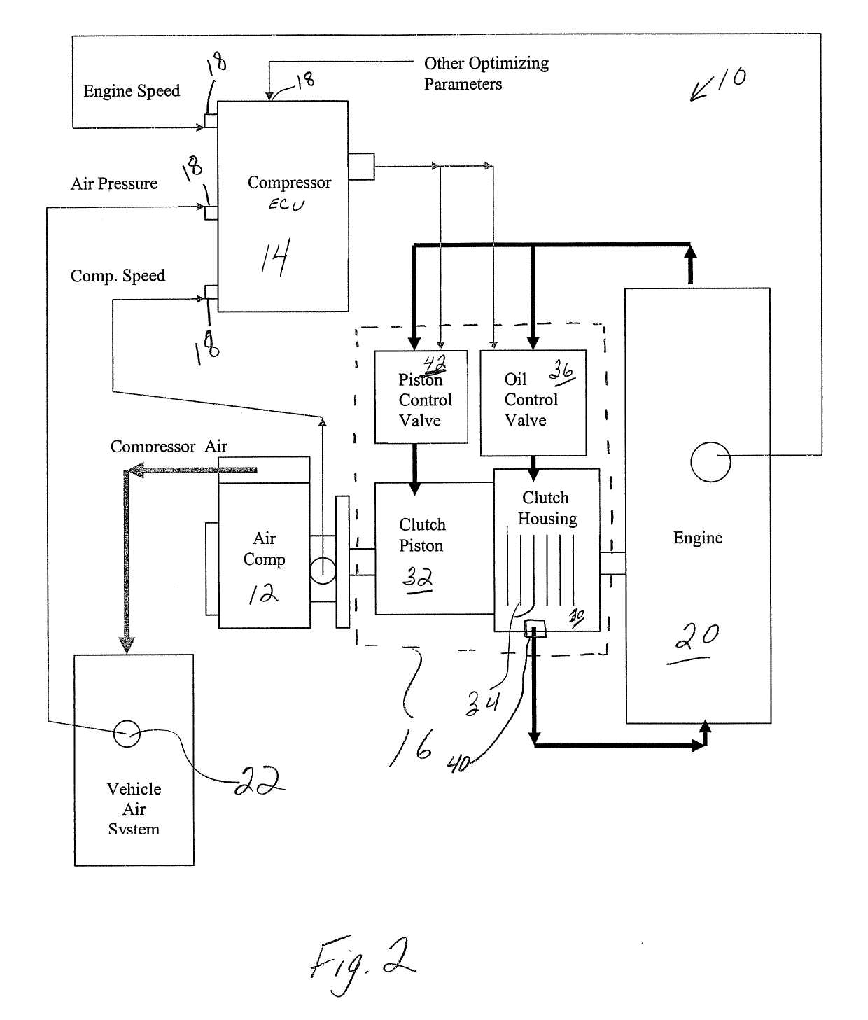

With reference to FIG. 2, the variable torque transmitter 16 is illustrated as a wet clutch in accordance with one embodiment of an apparatus illustrating principles of the present invention. In the illustrated embodiment, the variable torque transmitter (wet clutch) 16 includes a clutch housing 30 and a clutch piston 32. The clutch housing 30 includes a plurality of clutch plates 34, which engage each other as a function of pressure supplied by the clutch piston 32.

A first supply valve 36 is controlled by the compressor ECU 14 for delivering a cooling fluid to the clutch housing 30 for reducing heat generated between the clutch plates 34. It is contemplated that the compressor ECU 14 transmits an electronic signal for controlling the first supply valve 36; however, other signals (e.g., pneumatic signals) are also contemplated. In the illustrated embodiment, the cooling fluid is oil supplied from the engine 20, which is also recycled to the engine 20. However, it is also contemplated that the cooling fluid may be a gas (e.g., air), oil from a source independent of the engine, or some liquid that is not oil.

It is to be understood that viscous forces are created in the clutch housing 30 when a cooling fluid such as engine oil is present. Such viscous forces may be advantageous to help drive the compressor 12 when the clutch plates 34 are engaged. In other words, the viscous forces help increase the torque delivered to the compressor 12. However, the same viscous forces may create a drag on the engine 20 when the clutch plates 34 are disengaged from each other. Therefore, it is contemplated that the cooling fluid be reduced or drained from the clutch housing 30 when the clutch plates 34 are disengaged from each other. In that regard, a drain means 40 is used for controlling the removal of the cooling fluid from the clutch housing 30.

In one embodiment, the drain means 40 is a valve, which is controlled by the compressor ECU 14, for controlling the level of the cooling fluid in the clutch housing 30. More specifically, the compressor ECU 14 transmits a signal (e.g., an electronic or pneumatic signal) for opening/closing the drain valve 40 as a function of whether the clutch plates 34 are engaged/disengaged from each other.

In another embodiment, the drain means 40 is an orifice, which is always open and, therefore, not controlled by the compressor ECU 14. The orifice is sized for causing the cooling fluid to slowly and constantly bleed from the clutch housing 30.

A second supply valve 42, which is also controlled by the compressor ECU 14, delivers a fluid to a control cylinder associated with the clutch piston 32. The engagement/disengagement between the clutch plates 34 is controlled as a function of the amount of fluid in the clutch piston 32. More specifically, if the amount of fluid in the control cylinder of the clutch piston 32 is below a threshold level, the clutch plates 34 are disengaged from each other. Once the amount of fluid in the control cylinder of the clutch piston 32 reaches a threshold level, the clutch plates 34 become engaged with each other. However, at the threshold level of fluid, a maximum amount of slippage between the clutch plates 34 exists. The amount of slippage between the clutch plates 34 decreases as the amount of fluid in the control cylinder of the clutch piston 32 is increased.

In the illustrated embodiment, the fluid is oil supplied from the engine 20. However, it is also contemplated that the fluid may be a gas (e.g., air), oil from a source independent of the engine, hydraulic fluid, or some other liquid.

During use, if the pressure in the air tank 22 drops below a cut-in pressure (e.g., 110 psi), the compressor ECU 14 determines more pressure is needed in the air tank 22. Therefore, the compressor ECU 14 signals the second supply valve 42 to open so that the fluid flows into the control cylinder associated with the clutch piston 32. Once the fluid flows into the control cylinder, the clutch plates 34 begin to engage each other. As discussed above, the level of engagement between the clutch plates 34 (e.g., slippage) is a function of the level of the fluid in the control cylinder. At the same time, if the plates 34 are slipping, the compressor ECU 14 signals the first supply valve to open so that the cooling fluid flows into the clutch housing 32. If the drain means 40 is a valve, the compressor ECU 14 also closes that valve 40 to increase the cooling fluid level in the clutch housing 30; otherwise, the cooling fluid slowly begins to bleed from the clutch housing 30 via the orifice.

Once the plates 34 are no longer slipping, the compressor ECU 14 causes the first supply valve 36 to close (and the drain valve 40 to open) so that the cooling fluid drains from the clutch housing 30.

In one example, if the engine 20 is idling at 700 rpm and the compressor drive ratio is 2.5:1, the driving speed is 1,750 rpm (i.e., 700 rpm×2.5). If the actual speed of the compressor is less than a predetermined target speed of the compressor (e.g., 2,500 rpm), the compressor ECU 14 signals the second supply valve 42 to increase the level of fluid in the control cylinder of the clutch piston 32 to increase the torque transmitted to driving the compressor 12.

The amount of fluid in the control cylinder of the clutch piston 32 is increased until the target compressor driven speed is reached. However, in this case, even if the maximum amount of fluid is introduced into the control cylinder so that the pressure between the clutch plates 34 is maximized, the target compressor driven speed cannot be achieved because driving speed is less than the target compressor driven speed. Therefore, once the maximum amount of fluid flows into the control cylinder, no slippage exists between the clutch plates 34. Consequently, the cooling fluid is reduced in the clutch housing 30. The clutch remains engaged in this manner until the pressure in the reservoir tank reaches a governed pressure (e.g., 130 psi), at which time the second supply valve 42 is closed.

Because the clutch is capable of slipping to limit the actual driven speed of the compressor 12, higher compressor drive ratios (and driving speeds) may be used. Consequently, the compressor duty cycle at relatively low engine speeds (e.g., idling) may be minimized.

In another example, if the engine 20 is running at a higher speed than described above (e.g., the engine 20 is running at 2,100 rpm), and the pressure in the air tank 22 is again below the cut-in pressure, the compressor ECU 14 signals the second supply valve 42 to increase the level of fluid in the control cylinder to increase the torque transmitted to driving the compressor 12. Since the engine speed is 2,100 rpm, the driving speed is 5,250 rpm (i.e., 2,100 rpm×2.5). It is assumed that the actual compressor driven speed is initially less than the driving speed. Therefore, the compressor ECU 14 signals the second supply valve 42 to continue providing the fluid to the control cylinder so that the clutch control pressure increases until the target compressor driven speed (e.g., 2,500 rpm) is achieved.

It is to be understood that the driving speed is a function of engine speed (motor speed). The driving speed could also be determined via a power take-off from, for example, a transmission.

Since the driving speed (5,250 rpm) is greater than the target compressor driven speed (2,500 rpm), slippage between the clutch plates 34 is required to maintain the target compressor speed (so that the compressor 12 does not run too fast). Therefore, the first supply valve 36 is opened to maximize cooling fluid in the clutch housing 30. Operation in this manner is maintained until the pressure in the air tank 22 reaches the governed pressure, at which time the first and second supply valves 36, 42 are closed and the fluid drains from the control cylinder.

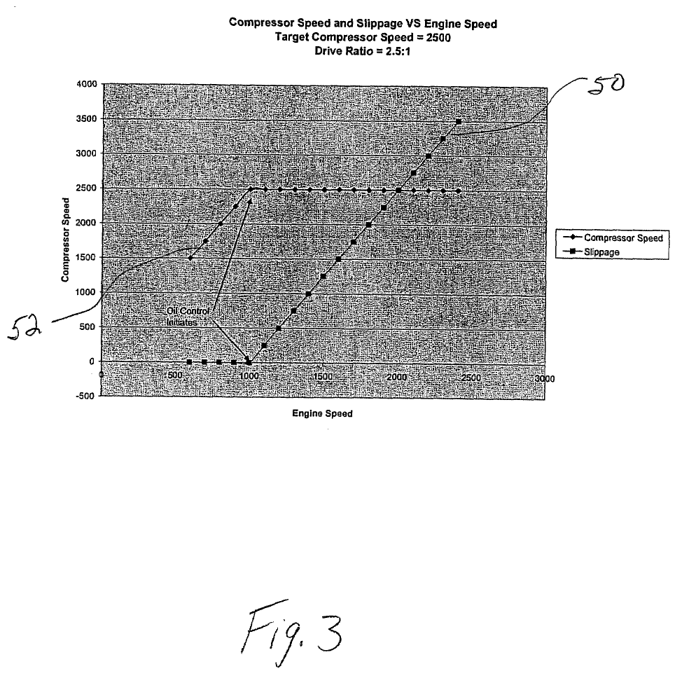

FIG. 3 is a graph including lines illustrating compressor speed 50 and slippage 52 versus engine speed for the second example discussed above (e.g., a target compressor speed of 2,500 rpm and a drive ratio of 2.5:1).

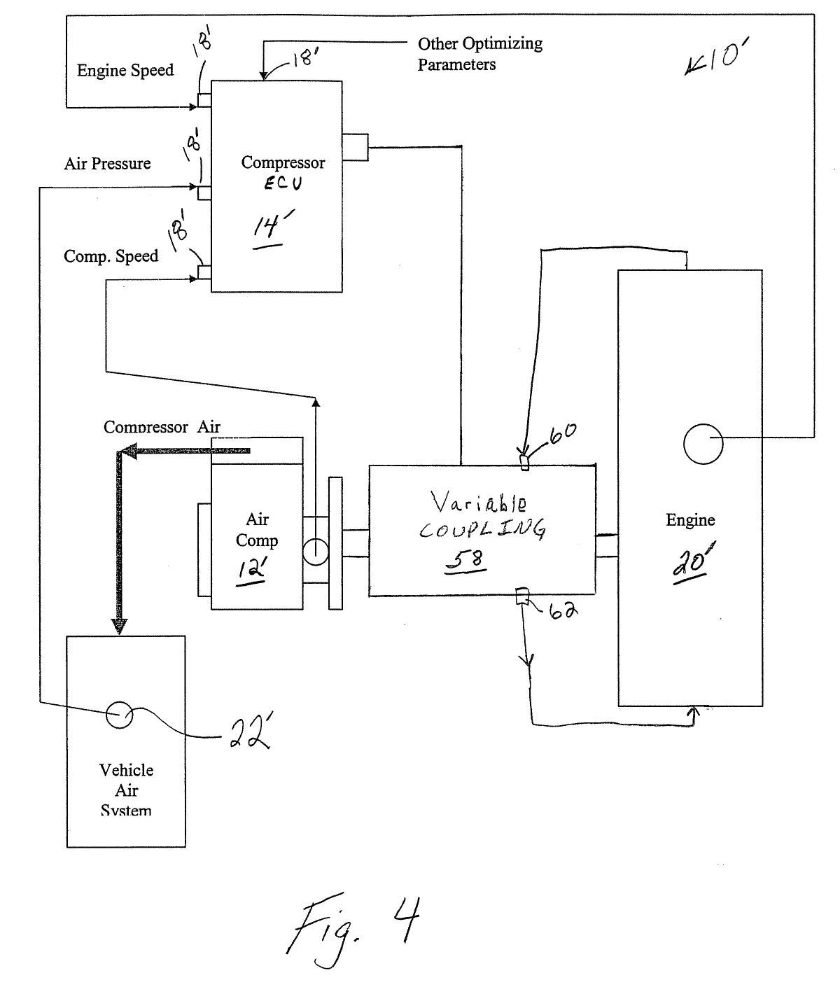

FIG. 4 illustrates a second embodiment of the vehicle air compressor controller system. For ease of understanding this embodiment of the present invention, like components are designated by like numerals with a primed (′) suffix and new components are designated by new numerals. In this embodiment, the variable torque transmitter 16 (see FIGS. 1 and 2) is illustrated as a variable coupling 58. The compressor ECU 14′ controls a supply valve 60 that supplies a fluid (e.g., oil, hydraulic fluid, etc.) to the variable coupling 58 and a drain valve 62 that reduces the fluid in the variable coupling 58. The compressor ECU 14′ controls the supply valve 60 and the drain valve 62 to maintain the fluid in the variable coupling 58 in a manner described above with respect to FIG. 2.

In one embodiment, the variable coupling 58 illustrated in FIG. 4 is a viscous coupling. In this embodiment, the fluid in the coupling 58 is relatively viscous. In addition, torque is transmitted through internal friction of the viscous fluid and adhesion of the viscous fluid to the inner surfaces of the variable coupling 58.

In another embodiment, the variable coupling 58 illustrated in FIG. 4 is a hydro-dynamic coupling (e.g., a torque converter). In this embodiment, the fluid moving through the variable coupling 58 is used for transmitting torque to the compressor 12′.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A vehicle air compressor controller, comprising:
an electronic control unit (ECU) adapted to control a compressor and receive a plurality of signals representing respective vehicle parameters; and
a variable torque transmitter, controlled by the ECU, receiving an engine speed from an engine of the vehicle and delivering a variable torque to a compressor of the vehicle for controlling a speed of the compressor, the variable torque being determined as a function of the engine speed and the vehicle parameters.

2. The vehicle air compressor controller as set forth in claim 1, wherein the variable torque transmitter includes:
a clutch engaged as a function of the engine speed and the vehicle parameters, the variable torque delivered to the compressor being determined as a function of the engagement of the clutch.

3. The vehicle air compressor controller as set forth in claim 2, wherein the clutch is a dry clutch.

4. The vehicle air compressor controller as set forth in claim 2, wherein the clutch is a wet clutch.

5. The vehicle air compressor controller as set forth in claim 4, further including:
a first valve controlled by the compressor ECU for delivering a cooling fluid to the clutch as a function of a slippage of the clutch.

6. The vehicle air compressor controller as set forth in claim 5, wherein:
the cooling fluid is oil; and
viscous forces created by the oil on the clutch increase the torque delivered to the compressor.

7. The vehicle air compressor controller as set forth in claim 5, further including:
a second valve controlled by the ECU for delivering a fluid to a control cylinder of the clutch for controlling a slippage of the clutch.

8. The vehicle air compressor controller as set forth in claim 7, wherein the fluid is one of hydraulic fluid and oil.

9. The vehicle air compressor controller as set forth in claim 1, wherein the variable torque transmitter includes:
a viscous coupling, a level of the viscous coupling being determined as a function of the engine speed and the vehicle parameters, the variable torque delivered to the compressor being determined as a function of the level of the viscous coupling.

10. The vehicle air compressor controller as set forth in claim 1, wherein the vehicle parameters include the speed of the compressor and a pressure of an air tank.

11. The vehicle air compressor controller as set forth in claim 1, wherein the vehicle parameters include a speed of the engine, the speed of the compressor, and a pressure of an air tank.

12. The vehicle air compressor controller as set forth in claim 11, wherein if the pressure of the air tank is below a cut-in pressure and the speed of the compressor is below a target compressor speed, the variable torque to the compressor is increased until one of i) the speed of the compressor reaches the target compressor speed and ii) the pressure in the air tank reaches a governed pressure.

13. The vehicle air compressor controller as set forth in claim 1, wherein the variable torque transmitter is a variable coupling.

14. The vehicle air compressor controller as set forth in claim 13, wherein the variable coupling is a viscous coupling.

15. The vehicle air compressor controller as set forth in claim 13, wherein the variable coupling is a hydro-dynamic coupling.

16. A vehicle air system, comprising:
an air compressor;
a reservoir receiving compressed air produced by the air compressor;
an engine for providing a torque to drive the compressor; and
a vehicle air compressor controller, comprising:
a compressor electronic control unit (ECU) receiving a plurality of signals representing a speed of the compressor, a pressure of the reservoir, and a speed of the engine; and
a variable torque transmitter, controlled by the compressor ECU, receiving the torque from the engine and delivering a variable torque to the air compressor for controlling the speed of the compressor, the variable torque being determined as a function of the speed of the compressor, the pressure of the reservoir, and the speed of the engine.

17. The vehicle air system as set forth in claim 16, wherein the variable torque transmitter includes:
a clutch engaged as a function of the engine speed and the vehicle parameters, the variable torque delivered to the compressor being determined as a function of the engagement of the clutch.

18. The vehicle air system as set forth in claim 17, wherein the clutch is a slipping clutch.

19. The vehicle air system as set forth in claim 18, further including:
a first valve controlled by the compressor ECU for delivering a cooling fluid to the clutch as a function of a slippage of the clutch.

20. The vehicle air system as set forth in claim 19, further including:
a second valve controlled by the compressor ECU for delivering a fluid to a control cylinder of the clutch for controlling a slippage of the clutch.

21. A vehicle air compressor controller, comprising:
a compressor electronic control unit (ECU) receiving a plurality of signals representing a speed of an associated compressor, a pressure of an associated reservoir, and a speed of an associated engine;
a clutch, controlled by the compressor ECU, receiving an engine torque from the engine and delivering a variable torque to the compressor for controlling a speed of the compressor, the variable torque being determined as a function of the engine speed, the speed of the compressor, the pressure of the reservoir, and the speed of the engine.

22. The vehicle air compressor controller as set forth in claim 21, wherein the clutch is a dry clutch.

23. The vehicle air compressor controller as set forth in claim 22, wherein the clutch is a wet clutch.

24. The vehicle air compressor controller as set forth in claim 23, further including:
a first valve controlled by the compressor ECU for delivering a cooling fluid to the clutch as a function of a slippage of the clutch; and
a second valve controlled by the compressor ECU for delivering a fluid to a control cylinder of the clutch for controlling a slippage of the clutch.

25. The vehicle air compressor controller as set forth in claim 24, wherein:
the cooling fluid is oil; and
viscous forces created by the oil in the clutch increase the torque delivered to the compressor.

26. A vehicle air compressor controller, comprising:
a compressor electronic control unit (ECU) receiving a plurality of signals representing respective vehicle parameters; and
means for delivering a variable torque to a compressor of a vehicle, for controlling a speed of the compressor, as a function of a signal received from the compressor ECU, the compressor ECU signal being determined as a function of a speed of an associated engine and the vehicle parameters.

27. The vehicle air compressor controller as set forth in claim 26, wherein the means for delivering includes:
a clutch engaged as a function of the engine speed and the vehicle parameters, the variable torque delivered to the compressor being determined as a function of the engagement of the clutch.

28. The vehicle air compressor controller as set forth in claim 27, wherein the clutch is a wet clutch.

29. The vehicle air compressor controller as set forth in claim 28, further including:
means for controlling a cooling fluid in the clutch as a function of a slippage of the clutch; and
means for controlling a fluid to a control cylinder of the clutch for controlling a slippage of the clutch.

30. The vehicle air compressor controller as set forth in claim 29, wherein the means for controlling the cooling includes:
a first valve controlling flow of the cooling fluid into the clutch.

31. The vehicle air compressor controller as set forth in claim 30, wherein the means for controlling the cooling further includes:
a second valve controlling flow of the cooling fluid out of the clutch.

32. The vehicle air compressor controller as set forth in claim 30, wherein the means for controlling the cooling further includes:
an orifice for controlling flow of the cooling fluid out of the clutch.

33. A method of varying a torque to a vehicle compressor, the method comprising:
receiving a plurality of signals representing vehicle parameters into a compressor electronic control unit (ECU);
receiving an engine speed from an engine of the vehicle into a variable torque transmitter; and
delivering a variable torque to a compressor of the vehicle for controlling a speed of the compressor, the variable torque being determined as a function of the engine speed and the vehicle parameters.

34. The method of varying a torque to a vehicle compressor as set forth in claim 33, wherein the delivering step includes:
engaging a clutch as a function of the engine speed and the vehicle parameters.

35. The method of varying a torque to a vehicle compressor as set forth in claim 34, further including:
if a driven speed of the compressor is less than a driving speed of the clutch, supplying a cooling fluid to the clutch.

36. The method of varying a torque to a vehicle compressor as set forth in claim 33, further including:
measuring the vehicle parameters including a speed of the engine, the speed of the compressor, and a pressure of an air tank.

37. The method of varying a torque to a vehicle compressor as set forth in claim 36, further including:
once a governed pressure in the air tank is reached, stopping the compressor.

38. The method of varying a torque to a vehicle compressor as set forth in claim 33, wherein the delivering step includes:
engaging a variable coupler as a function of the engine speed and the vehicle parameters.

39. A vehicle air compressor controller, comprising:
a compressor electronic control unit (ECU) adapted to control a compressor of the vehicle;
means for providing a plurality of signals to the compressor ECU, the signals representing respective vehicle parameters; and
a variable torque transmitter, controlled by the compressor ECU, receiving an engine speed from an engine of the vehicle and delivering a variable torque to the compressor of the vehicle for controlling a speed of the compressor, the variable torque being determined as a function of the engine speed and the vehicle parameters.
